(19) United States
(12) Patent Application Publication
(10) Pub. No.: US 2019/0074550 A1
(43) Pub. Date: Mar. 7, 2019

(54) ELECTRODE ASSEMBLY FOR SECONDARY BATTERY AND METHOD FOR PRODUCING ELECTRODE ASSEMBLY FOR SECONDARY BATTERY

(71) Applicant: Sumitomo Chemical Company, Limited, Tokyo (JP)

(72) Inventors: Yuichiro AZUMA, Niihama-shi (JP); Daizaburo YASHIKI, Niihama-shi (JP)

(21) Appl. No.: 16/118,397

(22) Filed: Aug. 30, 2018

(30) Foreign Application Priority Data
Sep. 5, 2017 (JP) 2017-170414

(51) Int. Cl. H01M 10/0587; H01M 10/0525

(52) U.S. Cl. CPC H01M 10/0587; H01M 10/0525

(57) ABSTRACT

An electrode assembly for a secondary battery includes: a roll including an electrode sheet and a first separator which are stacked and wound, the first separator including a functional layer and a film base material; and an adhesive tape securing a terminal end portion of the roll on an outer side of the roll. The adhesive tape is bonded (i) to an outer surface of the functional layer and (ii) to an end surface of the terminal end portion of the roll on the outer side of the roll.

This Nonprovisional application claims priority under 35 U.S.C. § 119 on Patent Application No. 2017-170414 filed in Japan on Sep. 5, 2017, the entire contents of which are hereby incorporated by reference.

### TECHNICAL FIELD

The present invention relates to an electrode assembly for a secondary battery and to a method for producing the electrode assembly for a secondary battery.

### BACKGROUND ART

In a production process for producing an electrode for a secondary battery, a roll in which an electrode sheet and a separator are wound is secured by an adhesive tape or the like at a portion of the roll at which portion the electrode sheet and the separator are wound up. Patent Literature 1 discloses a configuration in which an adhesive tape is attached to a portion of a roll at which portion the roll is wound up.

### CITATION LIST

### Patent Literature

[Patent Literature 1]

Japanese Patent Application Publication, Tokukai, No. 2015-210980 A

### SUMMARY OF INVENTION

### Technical Problem

However, the roll disclosed in Patent Literature 1 has a void between a separator and the adhesive tape at a terminal end portion of the separator. A functional layer of the separator may break due to being pulled by the adhesive tape. Further, in a case where an outermost layer of the roll is an electrode sheet, an active material layer of the electrode sheet may break due to a similar reason.

An object of one aspect of the present invention is to provide (i) an electrode assembly for a secondary battery which electrode assembly suppresses breakage of a functional layer of a separator or breakage of an active material layer of an electrode sheet and (ii) a method for producing the electrode assembly for a secondary battery.

### Solution to Problem

An electrode assembly, in accordance with one aspect of the present invention, for a secondary battery is an electrode assembly for a secondary battery, including: a roll including an electrode sheet and a separator which are stacked, the electrode sheet or the separator being wound, the electrode sheet including an active material layer and a current collector, the separator including a functional layer and a film base material; and an adhesive tape securing a terminal end portion of the roll on an outer side of the roll, the adhesive tape being bonded (i) to an outer surface of the active material layer or an outer surface of the functional layer and (ii) to an end surface of the terminal end portion.

A method, in accordance with one aspect of the present invention, for producing an electrode assembly for a secondary battery is a method for producing an electrode assembly for a secondary battery, the electrode assembly including a roll including an electrode sheet and a separator which are stacked, the electrode sheet or the separator being wound, the electrode sheet including an active material layer and a current collector, the separator including a functional layer and a film base material; the method including: a winding step including stacking and winding the electrode sheet and the separator; and an attaching step including securing a terminal end portion of the roll on an outer side of the roll with use of an adhesive tape so that the adhesive tape is bonded (i) to an outer surface of the active material layer or an outer surface of the functional layer and (ii) to an end surface of the terminal end portion.

### Advantageous Effects of Invention

According to the one aspect of the present invention, it is possible to suppress breakage of the functional layer of the separator or breakage of the active material layer of the electrode sheet.

### BRIEF DESCRIPTION OF DRAWINGS

(a) of FIG. 1 is a perspective view of an electrode assembly for a secondary battery of an embodiment, in which view the electrode assembly is partially rolled out. (b) and (c) of FIG. 1 are each a perspective view of the electrode assembly for a secondary battery.

FIG. 2 is an enlarged cross-sectional view of a terminal end portion of an outermost layer of a roll in a cross section perpendicular to an axis of the roll, in an electrode assembly of a reference example.

FIG. 3 is enlarged cross-sectional views each illustrating a terminal end portion of an outermost layer of a roll in a cross section perpendicular to an axis of the roll, in an electrode assembly of a reference example.

FIG. 4 is an enlarged cross-sectional view of a terminal end portion of an outermost layer of a roll in a cross section perpendicular to an axis of the roll, in an electrode assembly of an embodiment.

FIG. 5 is an enlarged cross-sectional view of a terminal end portion of an outermost layer of a roll in a cross section perpendicular to an axis of the roll, in a modified example of the electrode assembly.

FIG. 6 is an enlarged cross-sectional view of a terminal end portion of an outermost layer of a roll in a cross section perpendicular to an axis of the roll, in a modified example of the electrode assembly.

FIG. 7 is a schematic cross-sectional view illustrating a method for cutting a separator.

FIG. 8 is a schematic perspective view illustrating an example of a method for attaching an adhesive tape to a roll.

FIG. 9 is a cross-sectional view illustrating a step-by-step representation of a process of attaching an adhesive tape.

FIG. 10 is an enlarged cross-sectional view of a terminal end portion of an outermost layer of a roll in a cross section perpendicular to an axis of the roll, in a modified example of the electrode assembly.

FIG. 11 is an enlarged cross-sectional view of a terminal end portion of an outermost layer of a roll in a cross section perpendicular to an axis of the roll, in a modified example of the electrode assembly.

FIG. 12 is an enlarged cross-sectional view of a terminal end portion of an outermost layer of a roll in a cross section perpendicular to an axis of the roll, in a modified example of the electrode assembly.

FIG. 13 is an enlarged cross-sectional view of a terminal end portion of an outermost layer of a roll in a cross section perpendicular to an axis of the roll, in a modified example of the electrode assembly.

FIG. 14 is an image obtained by photographing a cross section of a sample of an electrode assembly corresponding to a configuration illustrated in FIG. 5.

FIG. 15 is an image obtained by photographing a cross section of a sample of an electrode assembly corresponding to a configuration illustrated in FIG. 6.

FIG. 16 is an enlarged cross-sectional view of a terminal end portion of an outermost layer of a roll in a cross section perpendicular to an axis of the roll, in an electrode assembly of an embodiment.

FIG. 17 is a schematic cross-sectional view illustrating a configuration of an electrode assembly of an embodiment.

### DESCRIPTION OF EMBODIMENTS

In one aspect of the present invention, a roll which includes (i) an electrode sheet which includes an active material layer and a current collector and (ii) a separator which includes a functional layer and a film base material includes at least (i) a portion where the electrode sheet and the separator overlap with each other and (ii) a portion where the electrode sheet or the separator is wound. That is, the roll may be (i) a roll which is obtained by winding the electrode sheet and the separator together in a state where the electrode sheet and the separator are stacked or (ii) a roll which is obtained by winding at least one of the electrode sheet and the separator around an outermost periphery of a stack of the electrode sheet and the separator so that the at least one of the electrode sheet and the separator runs along the entire outermost periphery at least once.

### Embodiment 1

(a) of FIG. 1 is a perspective view of an electrode assembly for a secondary battery of Embodiment 1, in which view the electrode assembly is partially rolled out. (b) of FIG. 1 is a perspective view of the electrode assembly for a secondary battery. An electrode assembly 1 for a secondary battery includes a roll 2 and an adhesive tape 3 securing a terminal end portion of an outermost layer of the roll 2. The roll 2 includes a negative electrode sheet 4, a positive electrode sheet 5, and two separators (a first separator 6 and a second separator 7). The two electrode sheets (the negative electrode sheet 4 and the positive electrode sheet 5) and the two separators (the first separator 6 and the second separator 7) are alternately stacked, and are wound. A negative electrode lead 4a is connected to the negative electrode sheet 4. A positive electrode lead 5a is connected to the positive electrode sheet 5. The negative electrode lead 4a and the positive electrode lead 5a are configured to be connected to a negative electrode and a positive electrode, respectively, of a secondary battery. The adhesive tape 3 is a tape to be attached to an outer peripheral surface of the roll 2 so as to secure the terminal end portion of the outermost layer of the roll 2 which is rolled up. The adhesive tape 3 may be wound around the roll 2 so as to run along an entire circumference of the roll 2, or may be attached to part of an outer periphery of the roll 2 without being wound so as to run along an entire circumference of the roll 2. Further, the adhesive tape 3 may be attached to a central portion of the roll 2 in an axial direction of the roll 2, or may be attached to a portion other than the central portion. The number of adhesive tape(s) 3 provided may be one, or may be more than one. A width of the adhesive tape 3 (a length of the adhesive tape 3 along the axial direction of the roll 2) may be any length. The width may be a length which allows the adhesive tape 3 to cover almost an entire width of the roll 2 along the axial direction of the roll 2, or may be a length which allows the adhesive tape 3 to cover part of the width of the roll 2 along the axial direction of the roll 2. The electrode assembly 1 is contained inside a battery can in order to constitute a secondary battery. Note that a length and a width of each of the negative electrode sheet 4, the positive electrode sheet 5, the first separator 6, and the second separator 7 illustrated in (a) of FIG. 1 are schematically shown and are not precise. The roll 2 illustrated in FIG. 1 may have a cylindrical shape in order to be contained inside a cylindrical battery can, or may have a flattened cylindrical shape, as illustrated in (c) of FIG. 1, in order to be contained inside a rectangular parallelepiped or bag-like battery container. A container in which the roll 2 is contained is not limited to a metal can, and may be a bag-like or box-like container into which a film that is a stack of resin and a metal foil is molded.

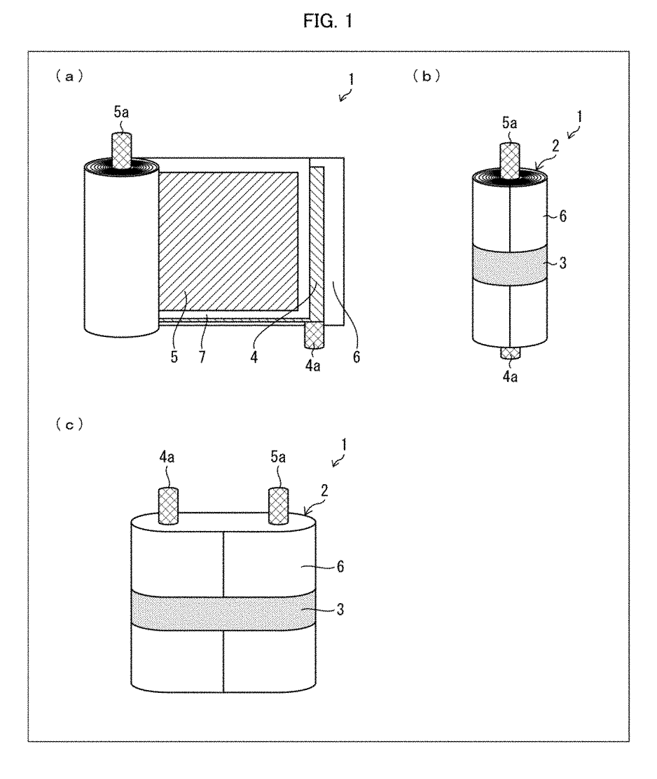

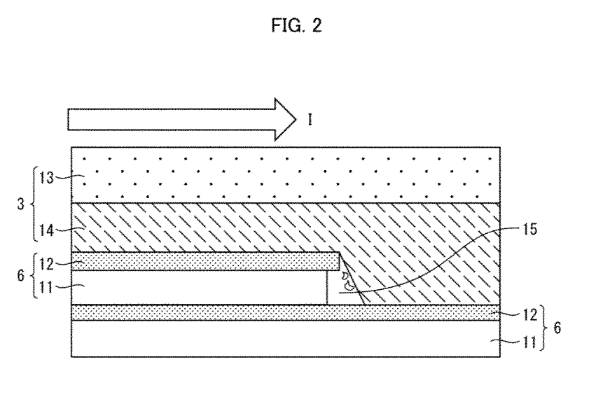

FIG. 2 is an enlarged cross-sectional view of a terminal end portion of an outermost layer of a roll in a cross section perpendicular to an axis of the roll, in an electrode assembly of Reference Example. A first separator 6 is located in the outermost layer of the roll. The first separator 6 includes a porous film base material 11 and a functional layer 12. Although the functional layer 12 in this example is provided on one surface of the porous film base material 11, the functional layer 12 may be provided on both surfaces of the porous film base material 11. The functional layer 12 is made of a material that is more fragile than the porous film base material 11 which is flexible.

The first separator 6 includes, for example, a heat-resistant layer as the functional layer 12. When a temperature of the first separator 6 is raised, the porous film base material 11 of the first separator 6 melts so as to block pores formed in the porous film base material 11. Through this, the film base material 11 stops movement of lithium ions and prevents overdischarge or overcharge of the secondary battery. Meanwhile, the heat-resistant layer does not undergo a change in shape even when the temperature of the first separator 6 is raised. That is, even in a case where the porous film base material 11 melts, the heat-resistant layer maintains a film shape of the first separator 6 without undergoing a change in shape. This allows reliably stopping movement of lithium ions.

The adhesive tape 3 includes a tape base material 13, which is a plastic film or the like, and an adhesive layer 14 for bonding. The adhesive layer 14 mainly contains an adhesive agent (or a bonding agent), and is provided on an inner surface of the tape base material 13. The first separator 6 is thinner and more flexible as compared with the adhesive tape 3 (especially as compared with the tape base material). The adhesive layer 14 is softer than the tape base material 13. Accordingly, the adhesive layer 14 is significantly deformed around a step formed by the terminal end portion of the first separator 6, and is bonded to an outer surface of the first separator 6.

In a step of attaching the adhesive tape 3, in order to prevent loosening of the rolled-up state of the roll, the adhesive tape 3 is attached to a portion of the first separator 6 which portion is in the outermost layer (on an upper side in FIG. 2), and then is attached to a portion of the first separator 6 which portion is on an inner side (on a lower side in FIG. 2) while being pulled in a circumferential direction (a direction indicated by an arrow I). Note that, in order to distinguish a portion of the first separator 6 which portion is located higher than the step formed by the terminal end portion of the first separator 6 and a portion of the first separator 6 which portion is located lower than the step, the former is herein referred to as a first separator 6 in the outermost layer and the latter is herein referred to as a first separator 6 on an inner side. The adhesive tape 3 is bonded to an outer surface of the functional layer 12 at the terminal end portion of the first separator 6. After the adhesive tape 3 is attached, a void 15 is formed next to an end surface of the terminal end portion of the first separator 6. The adhesive tape 3 pulls the functional layer 12 of the first separator 6 in the outermost layer in the circumferential direction (the direction indicated by the arrow I). This may cause the functional layer 12 in the outermost layer to be peeled off from the film base material 11 or break at the terminal end portion, and accordingly cause a bit of the functional layer 12 to fall off from the end surface of the first separator 6.

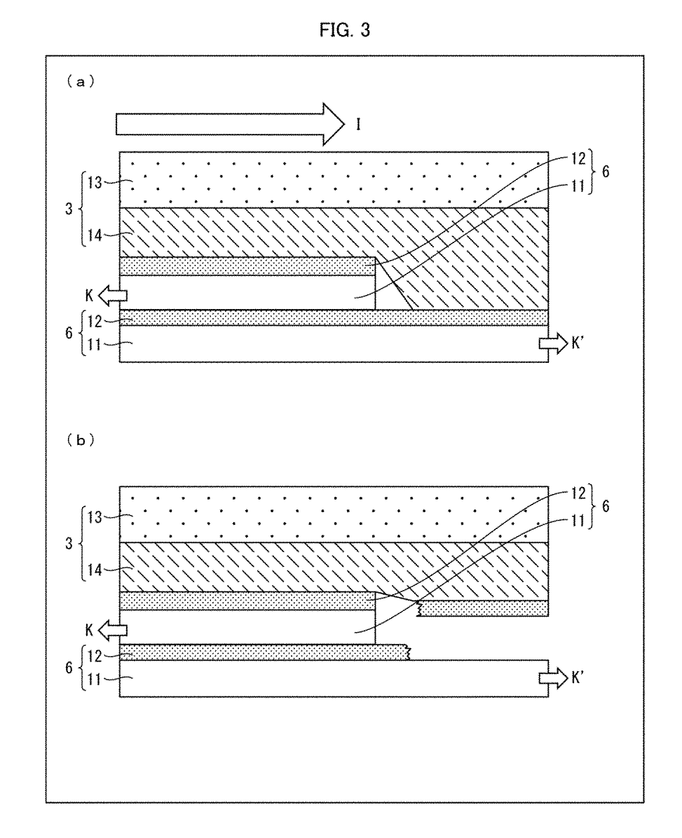

(a) and (b) of FIG. 3 are enlarged cross-sectional views each illustrating the terminal end portion of the outermost layer of the roll in a cross section perpendicular to the axis of the roll, in the electrode assembly of Reference Example. In the first place, contraction stress has been generated in the adhesive layer 14 which is deformed (stretched). Accordingly, the adhesive layer 14 which is deformed is pulling the functional layer 12 of the first separator 6 on the inner side toward the tape base material 13. When the secondary battery is charged, the electrode assembly, which includes the roll, expands outward. When seen locally, expansion of the electrode assembly urges the first separator 6 in the outermost layer to be displaced in a direction indicated by an arrow K and urges the first separator 6 on the inner side to be displaced in an opposite direction indicated by an arrow K′ ((a) of FIG. 3). In a case where an amount of deformation of the first separator 6 caused by this stress and an amount of deformation of the adhesive tape 3 differ from each other, the adhesive tape 3 pulls the functional layer 12 of the first separator 6 on the inner side in the direction indicated by the arrow K. This causes an increase in force by which the adhesive layer 14 which is deformed pulls the functional layer 12 of the first separator 6 on the inner side toward the tape base material 13. As a result, the functional layer 12 of the first separator 6 on the inner side may be peeled off from the film base material 11 ((b) of FIG. 3).

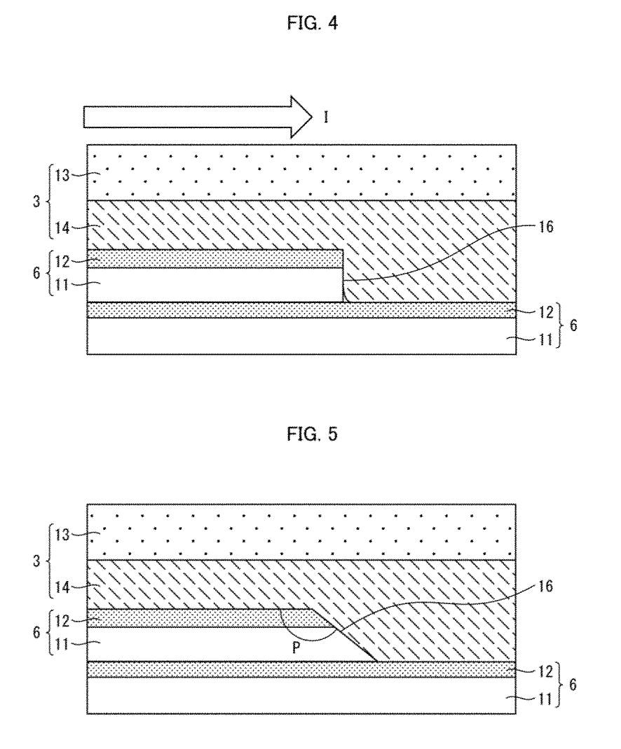

FIG. 4 is an enlarged cross-sectional view of the terminal end portion of the outermost layer of the roll 2 in a cross section perpendicular to the axis of the roll 2, in the electrode assembly 1 of Embodiment 1. The electrode assembly 1 is identical to the electrode assembly of Reference Example except that the adhesive layer 14 of the adhesive tape 3 is attached to an end surface 16 of the terminal end portion of the first separator 6 in the outermost layer. The first separator 6 is located in the outermost layer of the roll 2. In the first separator 6, a functional layer 12 is provided on an outer surface of a film base material 11. An adhesive layer 14 of the adhesive tape 3 is bonded to an outer surface of the functional layer 12. Further, the adhesive layer 14 of the adhesive tape 3 is bonded also to the end surface 16 of the terminal end portion of the first separator 6 in the outermost layer. In this example, the adhesive layer 14 of the adhesive tape 3 is bonded to an end surface of the functional layer 12 and to a portion of an end surface of the film base material 11 of the first separator 6 in the outermost layer. Note that the adhesive tape 3 only needs to be bonded to at least a portion of the end surface 16 of the first separator 6 in the outermost layer.

Since the adhesive tape 3 which has been attached while being pulled in a direction in which the roll 2 is rolled (in a direction indicated by an arrow I) is bonded also to a portion of the film base material 11 in the outermost layer, the adhesive tape 3 pulls not only the functional layer 12 but also the film base material 11 in the direction indicated by the arrow I. This allows suppressing peel-off of the functional layer 12 of the outermost layer from the film base material 11 and accordingly allows preventing breakage of the functional layer 12. Further, according to the configuration above, it is possible to prevent a bit of the functional layer 12 from falling off from the end surface 16.

Note that, since the adhesive tape 3 is bonded at least to the end surface of the functional layer 12 at the terminal end portion of the first separator 6 in the outermost layer, it is possible to (i) prevent a bit of the functional layer 12 from falling off from the end surface 16 and (ii) accordingly prevent progress of an interfacial peeling between the functional layer 12 and the film base material 11.

Further, since the adhesive tape 3 is bonded to the end surface 16 of the first separator 6 in the outermost layer, it is possible to reduce force by which the adhesive layer 14 pulls the functional layer 12 of the first separator 6 on the inner side toward the tape base material 13, even in a case where charging causes the electrode assembly 1 to expand. This enables suppression of peel-off, from the film base material 11, of the functional layer 12 of the first separator 6 on the inner side.

Note that although the above description discussed a configuration in which the functional layer 12 is provided on one surface of the film base material 11, the functional layer 12 may be provided on both surfaces of the film base material 11.

The electrode assembly 1 of Embodiment 1 can be produced in the following manner. In a winding step, the two electrode sheets (the negative electrode sheet 4 and the positive electrode sheet 5) and the two separators (the first separator 6 and the second separator 7) are alternately stacked and are wound so as to produce the roll 2. In an attaching step, the adhesive tape 3 is attached to the first separator 6 (on an upper side in FIG. 4) in the outermost layer and then is attached to the first separator 6 (on a lower side in FIG. 4) on an immediately inner side of the first separator 6 in the outermost layer while being pulled in the direction in which the roll 2 is rolled (in the direction indicated by the arrow I). The adhesive tape 3 is bonded to the outer surface of the functional layer 12 at the terminal end portion of the first separator 6. Subsequently, a portion (a portion on the right of the end surface 16 in FIG. 4) located lower than the step formed by the terminal end portion of the first separator 6 in the outermost layer is pressed by a pressing member over the adhesive tape 3. While the adhesive tape 3 is pressed by the pressing member, the pressing member is moved to a position beside the end surface 16 of the terminal end portion of the first separator 6 in the outermost layer so that the pressing member fits along the end surface 16. Note that, at this time, the pressing member does not have to press a portion (a portion on the left of the end surface 16 in FIG. 4) located higher than the step formed by the terminal end portion of the first separator 6 in the outermost layer. Accordingly, the void formed beside the end surface 16 can be removed, so that the adhesive layer 14, which is soft, can be bonded to the end surface 16.

### Modified Example 1

FIG. 5 is an enlarged cross-sectional view of a terminal end portion of an outermost layer of a roll 2 in a cross section perpendicular to an axis of the roll 2, in Modified Example 1 of the electrode assembly. A configuration of the electrode assembly of Modified Example 1 is identical to the above-described electrode assembly illustrated in FIG. 4, except that an end surface 16 of the terminal end portion of a first separator 6 in the outermost layer is an inclined surface. The end surface 16 of the terminal end portion of the first separator 6 is inclined with respect to an outer surface of the terminal end portion of the first separator 6. Specifically, in the cross section perpendicular to the axis of the roll 2, an internal angle P of the terminal end portion of the first separator 6 on an adhesive tape 3 side (on an outer side) is an obtuse angle. Accordingly, an adhesive layer 14 can be attached so as to fit along the inclined surface. This makes it easier to bond the adhesive layer 14 to the end surface 16. Further, since an area of the end surface 16 increases as compared with the configuration illustrated in FIG. 4, a bonding area between the adhesive layer 14 and the end surface 16 also increases. This enables suppression of breakage and peel-off of a functional layer 12.

### Modified Example 2

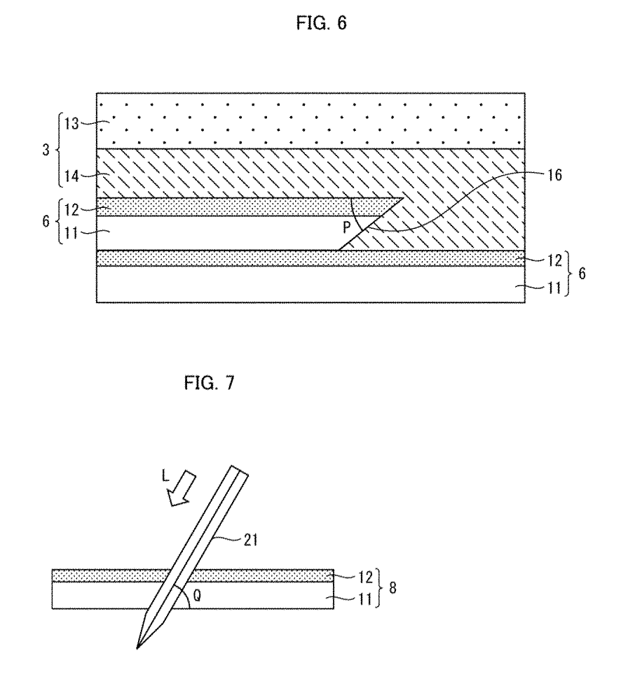

FIG. 6 is an enlarged cross-sectional view of a terminal end portion of an outermost layer of a roll 2 in a cross section perpendicular to an axis of the roll 2, in Modified Example 2 of the electrode assembly. A configuration of the electrode assembly of Modified Example 2 is identical to the above-described electrode assembly illustrated in FIG. 4, except that an end surface 16 of the terminal end portion of a first separator 6 in the outermost layer is an inclined surface. In the electrode assembly of Modified Example 2, inclination of the end surface 16 is opposite to that in Modified Example 1. The end surface 16 of the terminal end portion of the first separator 6 is inclined with respect to an outer surface of the terminal end portion of the first separator 6. Specifically, in the cross section perpendicular to the axis of the roll 2, an internal angle P of the terminal end portion of the first separator 6 on an adhesive tape 3 side (on an outer side) is an acute angle. An adhesive layer 14 is intruding under the end surface 16. Since an area of the end surface 16 increases as compared with the configuration illustrated in FIG. 4, a bonding area between the adhesive layer 14 and the end surface 16 also increases. This enables suppression of peel-off, from a film base material 11, of a functional layer 12 of the first separator 6 on an inner side.

FIG. 7 is a schematic cross-sectional view illustrating a method for cutting a separator. A long separator 8 which has been produced is cut into a predetermined length to be used in the electrode assembly 1, so that the first separator or the second separator is obtained. In FIG. 7, a cutting blade 21 is inserted obliquely into a surface of the separator 8. As a result, an end surface of the separator 8 which has been cut is an inclined surface. Note that in a case where the cutting blade 21 is inserted into the separator 8 from a film base material 11 side, the separator 8 which has been cut has a reverse inclined surface. The end surface of the separator 8 which has been cut has an angle Q which is preferably not more than 75°, more preferably not more than 70°. Note that the angle Q is one of two angles of a terminal end portion of the separator 8 which has been cut which one is an acute angle. The angle that is an acute angle can be on the film base material 11 side or on a functional layer 12 side, as illustrated in FIG. 5 or 6. An angle of an edge of the cutting blade 21 is preferably approximately 30° in a case where the cutting blade 21 is a double-edged blade, and is preferably approximately 15° to 25° in a case where the cutting blade 21 is a single-edged blade.

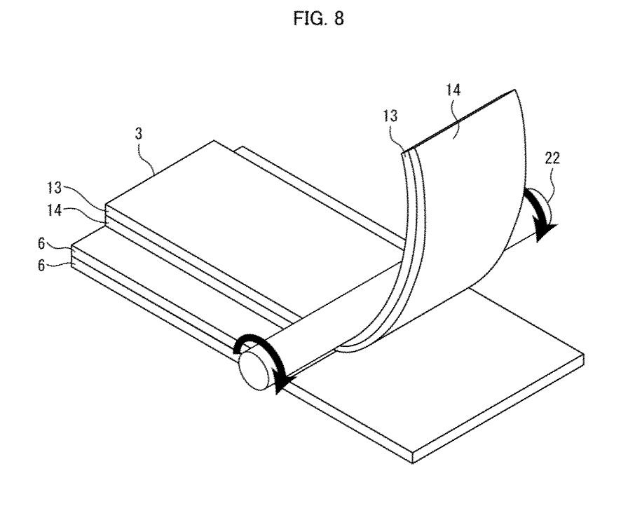

FIG. 8 is a schematic perspective view illustrating an example of a method for attaching the adhesive tape 3 to a roll in a manner illustrated in FIG. 6. In this example, a roller 22 is used to attach the adhesive tape 3 to the roll. In this example, the roller 22 is an unwrinkling roller having a plurality of grooves on a surface of the unwrinkling roller, the plurality of grooves being inclined with respect to a circumferential direction of the unwrinkling roller. Inclination of the plurality of grooves is reversed between on one side and on the other side of the roller 22 in an axial direction of the roller 22. Note that the roller 22 does not have to have any grooves. The roller 22 attaches the adhesive tape 3 to the roll by pressing the adhesive tape 3 while rotating so as to slide against a surface of the adhesive tape 3. A surface velocity of the roller 22 is higher than a velocity at which the adhesive tape 3 is attached.

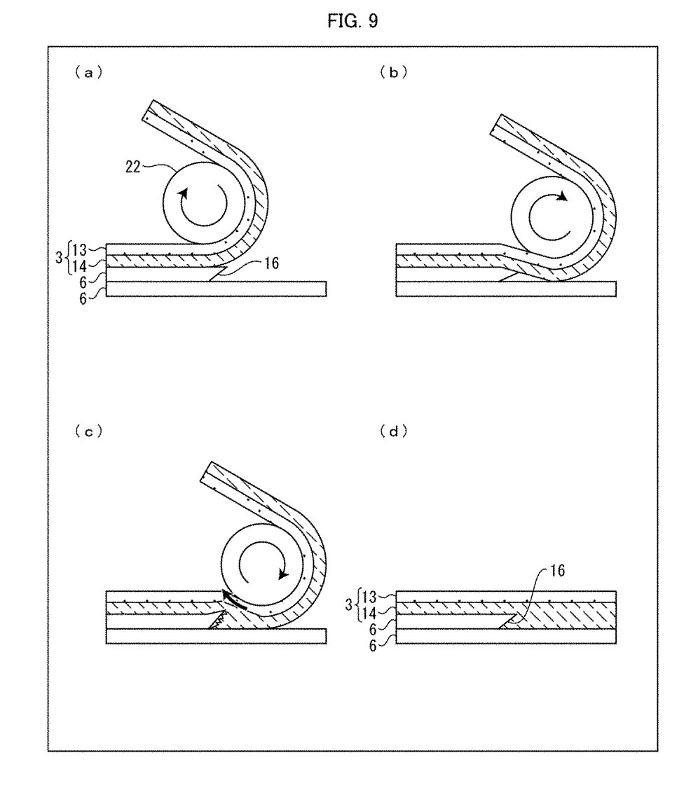

FIG. 9 is a cross-sectional view illustrating a step-by-step representation of a process of attaching the adhesive tape 3. First, the adhesive tape 3 is attached to the first separator 6 in the outermost layer ((a) of FIG. 9). When the roller 22 crosses over the step formed by the terminal end portion of the first separator 6 in the outermost layer, a tip of the terminal end portion is slightly crushed ((b) of FIG. 9). After the roller 22 crosses over the step, the roller 22 which is sliding against the surface of the adhesive tape 3 pushes the terminal end portion of the first separator 6 up. This raises the end surface 16 of the terminal end portion as well as causing the adhesive layer 14 to intrude under the end surface 16, so that the adhesive layer 14 is bonded to the end surface 16 ((c) of FIG. 9). After the adhesive tape 3 is attached, the tape base material 13 of the adhesive tape 3 does not follow a shape of the step formed by the first separator 6, and only the adhesive layer 14 deforms so as to fit along the step of the first separator 6 ((d) of FIG. 9). Thus, it is possible to bond the adhesive layer 14 also to the end surface 16 which is facing downward (facing inward).

### Modified Example 3

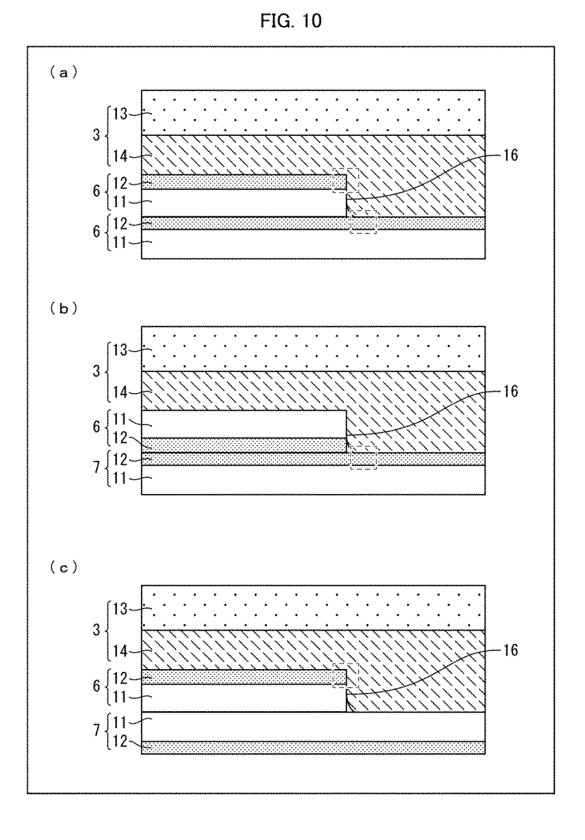

FIGS. 10 through 13 are cross-sectional views each illustrating a terminal end portion of an outermost layer in a cross section perpendicular to an axis of a roll in Modified Example 3 of the electrode assembly involving various directions which a functional layer 12 faces. In each of FIGS. 10 through 13, a portion within a broken line is a portion in which breakage of the functional layer 12 is prevented by an effect of one aspect of the present invention. Configurations illustrated in FIGS. 10 through 13 can be applied to the configurations illustrated in FIGS. 5 and 6 in each of which the end surface is an inclined surface.

In an electrode assembly illustrated in (a) of FIG. 10, both of (i) a functional layer 12 of a first separator 6 in the outermost layer and (ii) a functional layer 12 of a first separator 6 on an immediately inner side of the first separator 6 in the outermost layer face outward (an adhesive tape 3 side). An adhesive layer 14 is bonded to both the functional layers 12. According to this configuration, since the adhesive layer 14 is bonded to an end surface 16, it is possible to prevent breakage of the functional layer 12 of the first separator 6 in the outermost layer and breakage of the functional layer 12 of the first separator 6 on the immediately inner side.

In an electrode assembly illustrated in (b) of FIG. 10, a functional layer 12 of a first separator 6 in the outermost layer faces inward (on a side of the axis of the roll), and a functional layer 12 of a second separator 7 on an immediately inner side of the first separator 6 in the outermost layer faces outward (an adhesive tape 3 side). An adhesive layer 14 is bonded to the functional layer 12 of the second separator 7 on the immediately inner side. According to this configuration, since the adhesive layer 14 is bonded to an end surface 16, it is possible to prevent breakage of the functional layer 12 of the second separator 7 on the immediately inner side. Note that a terminal end portion of the second separator 7 on the immediately inner side is secured at another spot by an adhesive tape 3.

In an electrode assembly illustrated in (c) of FIG. 10, a functional layer 12 of a first separator 6 in the outermost layer faces outward (an adhesive tape 3 side), and a functional layer 12 of a second separator 7 on an immediately inner side of the first separator 6 in the outermost layer faces inward (on a side of the axis of the roll). An adhesive layer 14 is bonded to the functional layer of the first separator 6 in the outermost layer. According to this configuration, since the adhesive layer 14 is bonded to an end surface 16, it is possible to prevent breakage of the functional layer 12 of the first separator 6 in the outermost layer. Note that a terminal end portion of the second separator 7 on the immediately inner side is secured at another spot by an adhesive tape 3.

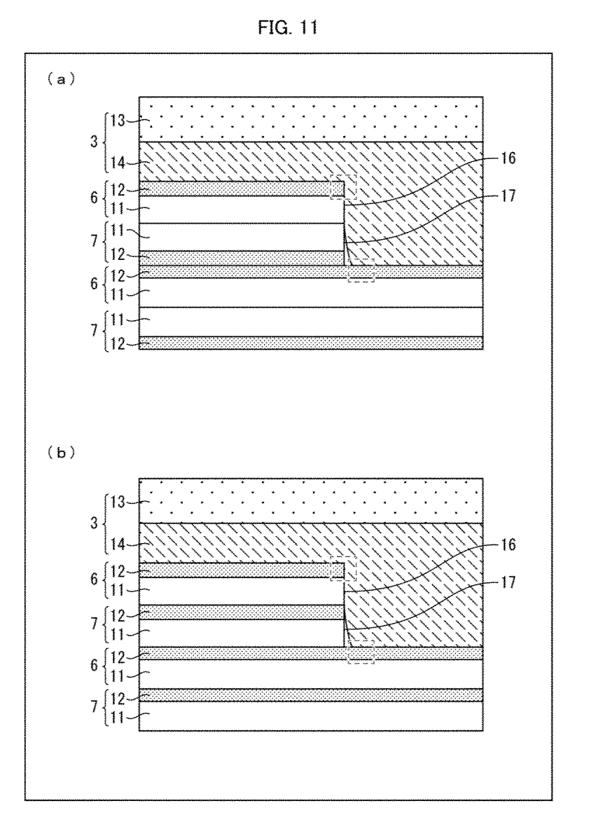

In each of electrode assemblies illustrated in (a) and (b) of FIG. 11, an end surface 16 of a terminal end portion of a first separator 6 in the outermost layer and an end surface 17 of a terminal end portion of a second separator 7 are aligned with each other.

In an electrode assembly illustrated in (a) of FIG. 11, a functional layer 12 of a first separator 6 in the outermost layer faces outward (an adhesive tape 3 side), and a functional layer 12 of a second separator 7 on an inner side faces inward (a side of an axis of a roll). An adhesive layer 14 is bonded to both of (i) the functional layer 12 of the first separator 6 which is located higher than a step formed by the terminal end portion of the first separator 6 and (ii) a functional layer 12 of a first separator 6 which is located lower than the step. The adhesive layer 14 is bonded at least to an end surface 16 of the first separator 6 in the outermost layer. The adhesive layer 14 may be bonded to an end surface 17 of the second separator 7 on the inner side. According to this configuration, since the adhesive layer 14 is bonded to the end surface 16, it is possible to prevent (i) breakage of the functional layer 12 of the first separator 6 which is located higher than the step formed by the terminal end portion and (ii) breakage of the functional layer 12 of the first separator 6 which is located lower than the step formed by the terminal end portion.

In an electrode assembly illustrated in (b) of FIG. 11, both of (i) a functional layer 12 of a first separator 6 in the outermost layer and (ii) a functional layer 12 of a second separator 7 on an inner side face outward (an adhesive tape 3 side). An adhesive layer 14 is bonded to both of (i) the functional layer 12 of the first separator 6 which is located higher than a step formed by the terminal end portion of the first separator 6 and (ii) a functional layer 12 of a first separator 6 which is located lower than the step. The adhesive layer 14 is bonded at least to an end surface 16 of the first separator 6 in the outermost layer. The adhesive layer 14 may be bonded to an end surface 17 of the second separator 7 on the inner side. According to this configuration, since the adhesive layer 14 is bonded to the end surface 16, it is possible to prevent (i) breakage of the functional layer 12 of the first separator 6 which is located higher than the step formed by the terminal end portion and (ii) breakage of the functional layer 12 of the first separator 6 which is located lower than the step formed by the terminal end portion.

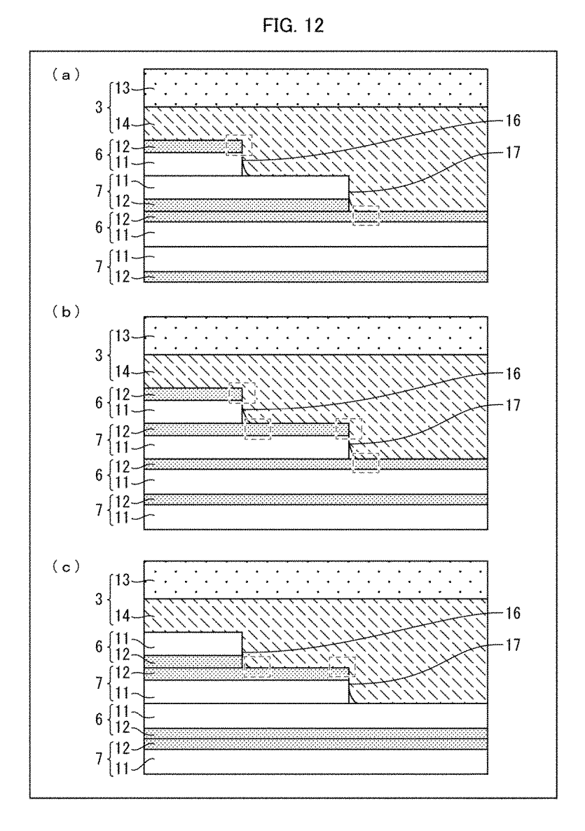

In each of electrode assemblies illustrated in (a) through (c) of FIG. 12, an end surface 17 of a terminal end portion of a second separator 7 is located slightly in front of an end surface 16 of a terminal end portion of a first separator 6 in the outermost layer. Accordingly, in a state where the adhesive tape 3 has not been attached the roll, a portion of an outer surface of the second separator 7 is exposed.

In the electrode assembly illustrated in (a) of FIG. 12, a functional layer 12 of the first separator 6 in the outermost layer faces outward (an adhesive tape 3 side), and a functional layer 12 of the second separator 7 on an inner side faces inward (a side of the axis of the roll). An adhesive layer 14 is bonded to the functional layer 12 of the first separator 6 which is located higher than a step formed by the terminal end portion of the first separator 6. The adhesive layer 14 is bonded to a film base material 11 of the second separator 7 which is located lower than the step formed by the terminal end portion of the first separator 6 and is located higher than a step formed by the terminal end portion of the second separator 7. The adhesive layer 14 is bonded to a functional layer 12 of a first separator 6 which is located lower than the step formed by the terminal end portion of the second separator 7. The adhesive layer 14 is bonded to the end surface 16 of the first separator 6 in the outermost layer. According to this configuration, since the adhesive layer 14 is bonded to the end surface 16, it is possible to prevent breakage of the functional layer 12 of the first separator 6 which is located higher than the step formed by the terminal end portion of the first separator 6. Further, the adhesive layer 14 is bonded to the end surface 17 of the second separator 7. According to this configuration, since the adhesive layer 14 is bonded to the end surface 17, it is possible to prevent breakage of the functional layer 12 of the first separator 6 which is located lower than the step formed by the terminal end portion of the second separator 7.

In the electrode assembly illustrated in (b) of FIG. 12, both of (i) a functional layer 12 of the first separator 6 in the outermost layer and (ii) a functional layer 12 of the second separator 7 on an inner side face outward (an adhesive tape 3 side). An adhesive layer 14 is bonded to the functional layer 12 of the first separator 6 which is located higher than a step formed by the terminal end portion of the first separator 6. The adhesive layer 14 is bonded to the functional layer 12 of the second separator 7 which is located lower than the step formed by the terminal end portion of the first separator 6 and is located higher than a step formed by the terminal end portion of the second separator 7. The adhesive layer 14 is bonded to a functional layer 12 of a first separator 6 which is located lower than the step formed by the terminal end portion of the second separator 7. The adhesive layer 14 is bonded to the end surface 16 of the first separator 6 in the outermost layer. According to this configuration, since the adhesive layer 14 is bonded to the end surface 16, it is possible to prevent (i) breakage of the functional layer 12 of the first separator 6 which is located higher than the step formed by the terminal end portion of the first separator 6 and (ii) breakage of the functional layer 12 of the second separator 7. Further, the adhesive layer 14 is bonded to the end surface 17 of the second separator 7. According to this configuration, since the adhesive layer 14 is bonded to the end surface 17, it is possible to prevent (i) breakage of the functional layer 12 of the second separator 7 and (ii) breakage of the functional layer 12 of the first separator 6 which is located lower than the step formed by the terminal end portion of the second separator 7.

In the electrode assembly illustrated in (c) of FIG. 12, a functional layer 12 of the first separator 6 in the outermost layer faces inward (a side of the axis of the roll), and a functional layer 12 of the second separator 7 on an inner side faces outward (an adhesive tape 3 side). An adhesive layer 14 is bonded to a film base material 11 of the first separator 6 which is located higher than a step formed by the terminal end portion of the first separator 6. The adhesive layer 14 is bonded to the functional layer 12 of the second separator 7 which is located higher than a step of the terminal end portion of the second separator 7. The adhesive layer 14 is bonded to a film base material 11 of a first separator 6 which is located lower than the step formed by the terminal end portion of the second separator 7. The adhesive layer 14 is bonded to the end surface 16 of the first separator 6 in the outermost layer. According to this configuration, since the adhesive layer 14 is bonded to the end surface 16, it is possible to prevent breakage of the functional layer 12 of the second separator 7. Further, the adhesive layer 14 is bonded to the end surface 17 of the second separator 7. According to this configuration, since the adhesive layer 14 is bonded to the end surface 17, it is possible to prevent breakage of the functional layer 12 of the second separator 7.

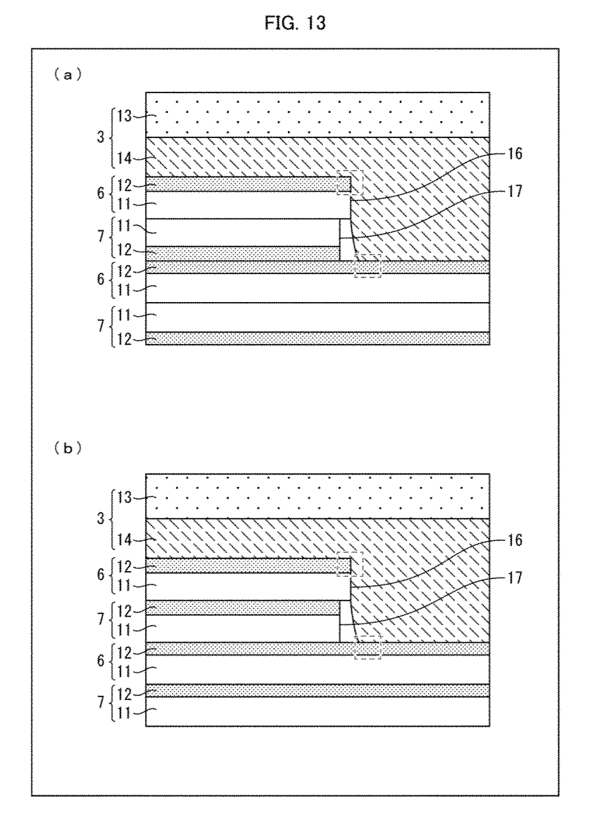

In each of electrode assemblies illustrated in (a) and (b) of FIG. 13, an end surface 17 of a terminal end portion of a second separator 7 is located slightly behind an end surface 16 of a terminal end portion of a first separator 6 in the outermost layer. Accordingly, in a state where an adhesive tape 3 has not been attached to the roll, an outer surface of the second separator 7 is not exposed but the end surface 17 of the second separator 7 is exposed.

In the electrode assembly illustrated in (a) of FIG. 13, a functional layer 12 of the first separator 6 in the outermost layer faces outward (an adhesive tape 3 side) and a functional layer 12 of the second separator 7 on an inner side faces inward (a side of the axis of the roll). An adhesive layer 14 is bonded to the functional layer 12 of the first separator 6 which is located higher than a step formed by the terminal end portion of the first separator 6. The adhesive layer 14 is bonded to the functional layer 12 of the first separator 6 which is located lower than the step formed by the terminal end portion of the first separator 6. The adhesive layer 14 is bonded to the end surface 16 of the first separator 6 in the outermost layer. According to this configuration, since the adhesive layer 14 is bonded to the end surface 16, it is possible to prevent (i) breakage of the functional layer 12 of the first separator 6 which is located higher than the step formed by the terminal end portion of the first separator 6 and (ii) breakage of the functional layer 12 of the first separator 6 which is located lower than the step formed by the terminal end portion of the first separator 6.

In the electrode assembly illustrated in (b) of FIG. 13, both of (i) a functional layer 12 of the first separator 6 in the outermost layer and (ii) a functional layer 12 of the second separator 7 on an inner side face outward (an adhesive tape 3 side). A portion where the adhesive layer 14 is bonded is identical to that in the configuration illustrated in (a) of FIG. 13. According to this configuration, as with the configuration illustrated in (a) of FIG. 13, since the adhesive layer 14 is bonded to the end surface 16, it is possible to prevent (i) breakage of the functional layer 12 of the first separator 6 which is located higher than a step formed by the terminal end portion of the first separator 6 and (ii) breakage of the functional layer 12 of the first separator 6 which is located lower than the step formed by the terminal end portion of the first separator 6.

Note that, in a case where the film base material 11 of the first separator 6 in the outermost layer faces outward (the adhesive tape 3 side) as illustrated in (b) of FIG. 10 or (c) of FIG. 12, the adhesive tape 3 is bonded to the film base material 11 of the first separator 6. As such, there is no need to be concerned that the adhesive tape 3 may break the functional layer 12 of the first separator 6. However, the functional layer 12 of the first separator 6 faces a direction that is opposite to a direction which the functional layer 12 of the second separator 7 faces. Accordingly, in a process for producing an electrode assembly, an operator is more prone to mistake a direction in which a separator roll, which is a material, is set to an axis.

Meanwhile, in (a) of FIG. 10, (b) of FIG. 12, and the like, both of the functional layer 12 of the first separator 6 and the functional layer 12 of the second separator 7 face outward (the adhesive tape 3 side). In this case, in a process for producing an electrode assembly, an operator is less prone to mistake a direction in which a separator roll, which is a material, is set to an axis, since the direction is the same between the functional layer 12 of the first separator 6 and the functional layer 12 of the second separator 7. Further, in the example above, the adhesive tape 3 is bonded to the end surface 16 of the first separator 6 or the end surface 17 of the second separator 7. This makes it possible to suppress breakage of the functional layers 12 which faces outward.

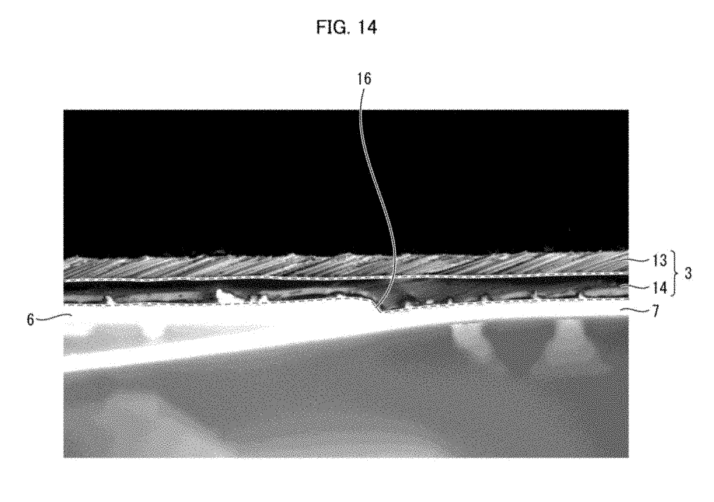

FIG. 14 is an image obtained by photographing a cross section of a sample of an electrode assembly corresponding to the configuration illustrated in FIG. 5. For visibility, lines are added to indicate an interface between an adhesive layer 14 and a tape base material 13 and an interface between the adhesive layer 14 and a separator. In this example, only a terminal end portion to which an adhesive tape 3 was attached was taken and photographed with use of a laser microscope. Accordingly, a space is formed between a first separator 6 and a second separator 7 at a portion far from an end surface 16. Note that a functional layer of the first separator 6 and a functional layer of the second separator 7 face an adhesive tape 3 side. As shown in FIG. 14, the adhesive layer 14 is bonded to the end surface 16 of the first separator 6, and hardly any void is observed near the end surface 16.

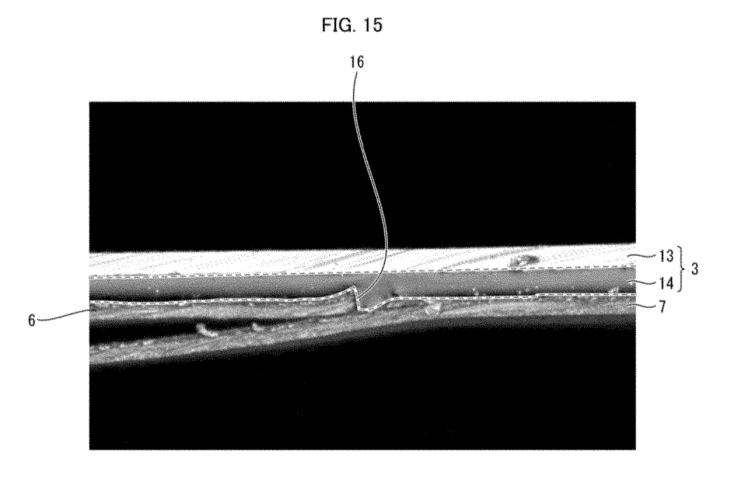

FIG. 15 is an image obtained by photographing a cross section of a sample of an electrode assembly corresponding to the configuration illustrated in FIG. 6. For visibility, lines are added to indicate an interface between an adhesive layer 14 and a tape base material 13 and an interface between the adhesive layer 14 and a separator. In this example, only a terminal end portion to which an adhesive tape 3 was attached was taken and photographed with use of a laser microscope. Note that a functional layer of a first separator 6 and a functional layer of a second separator 7 face an adhesive tape 3 side. As shown in FIG. 15, a tip of the first separator 6 is slightly lifted, and the adhesive layer 14, which is deformed, is intruding between an end surface 16 and the second separator 7.

### Embodiment 2

The following description will discuss Embodiment 2 of the present invention. For easy explanation, the same reference signs will be given to members having the same function as a member described in Embodiment 1, and descriptions on such a member will be omitted. In Embodiment 1, an example has been discussed in which example an outermost layer of a roll is a separator. In Embodiment 2, an example will be discussed in which example an outermost layer of a roll is an electrode sheet.

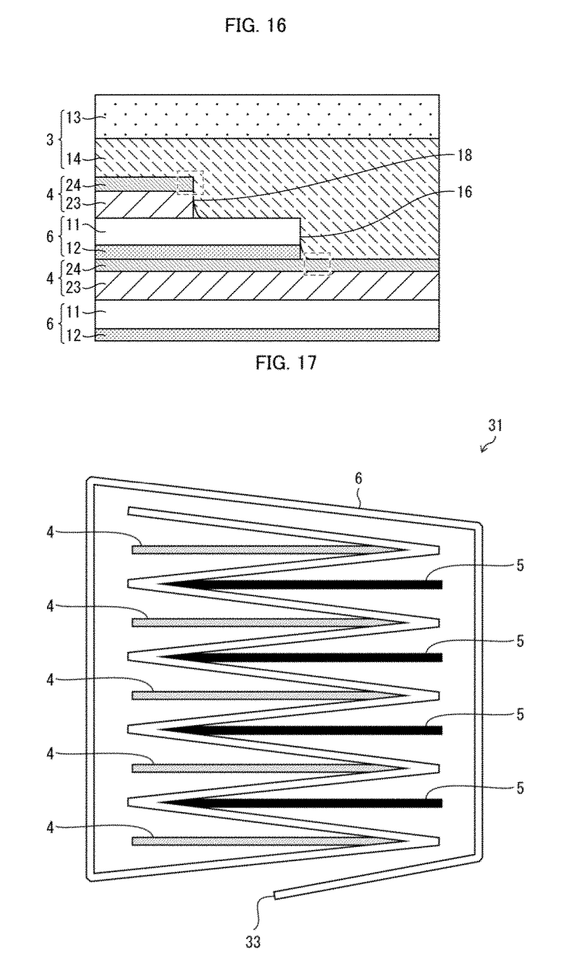

FIG. 16 is an enlarged cross-sectional view illustrating a terminal end portion of an outermost layer of a roll in a cross section perpendicular to an axis of the roll in an electrode assembly of Embodiment 2. In the electrode assembly of Embodiment 2, a second separator, a positive electrode sheet, a first separator 6, and a negative electrode sheet 4 are stacked in this order from an inner side, and are wound. Accordingly, the negative electrode sheet 4 is located in the outermost layer of the roll. The negative electrode sheet 4 includes a negative electrode current collector 23, which is a metal conductive foil, and a negative electrode active material layer 24, which is provided on the negative electrode current collector 23. In this example, the negative electrode active material layer 24 is formed by being applied onto the negative electrode current collector 23, and is made of a material which is more fragile than that of the negative electrode current collector 23. Similarly, although not illustrated, the positive electrode sheet includes a positive electrode current collector, which is a metal conductive foil, and a positive electrode active material layer which is provided on the positive electrode current collector.

In the electrode assembly illustrated in FIG. 16, an end surface 16 of a terminal end portion of the first separator 6 is located slightly in front of an end surface 18 of a terminal end portion of the negative electrode sheet 4 in the outermost layer. Accordingly, in a state where an adhesive tape 3 has not been attached to the roll, a portion of an outer surface of the first separator 6 is exposed. The negative electrode active material layer 24 of the negative electrode sheet 4 in the outermost layer faces outward (an adhesive tape 3 side), and a functional layer 12 of the first separator 6 on an inner side faces inward (a side of the axis of the roll). An adhesive layer 14 of the adhesive tape 3 is bonded to an outer surface of the negative electrode active material layer 24 of the negative electrode sheet 4 which is located higher than a step formed by the terminal end portion of the negative electrode sheet 4. The adhesive layer 14 is bonded to an outer surface of a film base material 11 of the first separator 6 which is located lower than the step formed by the terminal end portion of the negative electrode sheet 4 and is located higher than a step formed by a terminal end portion of the first separator 6. The adhesive layer 14 is bonded to an outer surface of a negative electrode active material layer 24 of a negative electrode sheet 4 which is located lower than the step formed by the terminal end portion of the first separator 6. In this example, the adhesive layer 14 of the adhesive tape 3 is bonded to an end surface of the negative electrode active material layer 24 of the negative electrode sheet 4 in the outermost layer and to a portion of an end surface of the negative electrode current collector 23. Note that the adhesive tape 3 only needs to be bonded at least to a portion of the end surface 18 of the negative electrode sheet 4 in the outermost layer. According to this configuration, since the adhesive layer 14 is bonded to the end surface 18 of the negative electrode sheet 4, it is possible to prevent breakage of the negative electrode active material layer 24 of the negative electrode sheet 4 which is located higher than the step formed by the terminal end portion of the negative electrode sheet 4. Further, the adhesive layer 14 of the adhesive tape 3 is bonded to the end surface 16 of the first separator 6. According to this configuration, since the adhesive layer 14 is bonded to the end surface 16 of the first separator 6, it is possible to prevent breakage of the negative electrode active material layer 24 of the negative electrode sheet 4 which is located lower than the step formed by the terminal end portion of the first separator 6.

Thus, even in a case of a configuration in which the negative electrode sheet 4 or the positive electrode sheet 5 is exposed to an outer side of the roll, it is possible to bond the adhesive tape 3 to an end surface of the negative electrode sheet 4 or the positive electrode sheet 5. In the above-described configurations of Embodiment 1, the first separator 6 or the second separator 7 may be replaced with the negative electrode sheet 4 or the positive electrode sheet 5. Note, however, that it is necessary that the electrode sheets and the separators be arranged so that the first separator 6 or the second separator 7 is interposed between the negative electrode sheet 4 and the positive electrode sheet 5.

Note that the above description has discussed a configuration in which an active material layer is provided on one surface of a metal conductive foil of an electrode sheet of each of the positive electrode and the negative electrode, but the active material layer may be provided on both surfaces of the metal conductive foil.

### Embodiment 3

The following description will discuss Embodiment 3 of the present invention. For easy explanation, the same reference signs will be given to members having the same function as a member described in each of Embodiments 1 and 2, and descriptions on such a member will be omitted.

FIG. 17 is a cross-sectional view schematically illustrating a configuration of an electrode assembly of Embodiment 3. A roll 31 of Embodiment 3 includes a first separator 6, a plurality of negative electrode sheets 4, and a plurality of positive electrode sheets 5. The plurality of negative electrode sheets 4 and the plurality of positive electrode sheets 5 are alternately stacked, and the first separator 6 is passed through between each adjacent electrode sheets. The first separator 6 is wound around an outermost periphery of a stack of the first separator 6, the plurality of negative electrode sheets 4, and the plurality of positive electrode sheets 5. An adhesive tape (not illustrated) is attached to an outer peripheral surface of the roll 31 in order to secure a terminal end portion 33 of an outermost layer of the roll 31.

The present invention is not limited to the embodiments, but can be altered by a skilled person in the art within the scope of the claims. The present invention also encompasses, in its technical scope, any embodiment derived by combining technical means disclosed in differing embodiments.

[Recap]

An electrode assembly, in accordance with one aspect of the present invention, for a secondary battery is an electrode assembly for a secondary battery, including: a roll including an electrode sheet and a separator which are stacked, the electrode sheet or the separator being wound, the electrode sheet including an active material layer and a current collector, the separator including a functional layer and a film base material; and an adhesive tape securing a terminal end portion of the roll on an outer side of the roll, the adhesive tape being bonded (i) to an outer surface of the active material layer or an outer surface of the functional layer and (ii) to an end surface of the terminal end portion.

According to the above configuration, since the adhesive tape is bonded to the end surface of the terminal end portion of the roll, it is possible to suppress breakage of the active material layer or the functional layer which breakage may otherwise be caused in a case where the adhesive tape pulls the active material layer or the functional layer.

The electrode assembly may be configured such that the adhesive tape is bonded, at the end surface of the terminal end portion, (i) to an end surface of the active material layer and an end surface of the current collector or (ii) to an end surface of the functional layer and an end surface of the film base material.

The electrode assembly may be configured such that the end surface of the terminal end portion is inclined with respect to an outer surface of the terminal end portion.

The electrode assembly may be configured such that an outermost layer of the roll is the separator.

The electrode assembly may be configured such that the separator is a first separator; the electrode assembly further includes a second separator which includes a functional layer and a film base material; and the adhesive tape is bonded (i) to the outer surface of the functional layer of the first separator or an outer surface of the functional layer of the second separator and (ii) to an end surface of the first separator at the terminal end portion and an end surface of a terminal end portion of the second separator.

A method, in accordance with one aspect of the present invention, for producing an electrode assembly for a secondary battery is a method for producing an electrode assembly for a secondary battery, the electrode assembly including a roll including an electrode sheet and a separator which are stacked, the electrode sheet or the separator being wound, the electrode sheet including an active material layer and a current collector, the separator including a functional layer and a film base material; the method including: a winding step including stacking and winding the electrode sheet and the separator; and an attaching step including securing a terminal end portion of the roll on an outer side of the roll with use of an adhesive tape so that the adhesive tape is bonded (i) to an outer surface of the active material layer or an outer surface of the functional layer and (ii) to an end surface of the terminal end portion.

The method may be configured such that the attaching step includes bonding, at the end surface of the terminal end portion, the adhesive tape (i) to an end surface of the active material layer and an end surface of the current collector or (ii) to an end surface of the functional layer and an end surface of the film base material.

The method may be configured such that the end surface of the terminal end portion is inclined with respect to an outer surface of the terminal end portion.

The method may be configured such that an outermost layer of the roll is the separator.

The method may be configured such that: the separator is a first separator; the winding step includes stacking and winding the electrode sheet, the first separator, and a second separator, the second separator including a functional layer and a film base material; and the attaching step includes bonding the adhesive tape (i) to the outer surface of the functional layer of the first separator or an outer surface of the functional layer of the second separator and (ii) to an end surface of the first separator at the terminal end portion and an end surface of a terminal end portion of the second separator.

### REFERENCE SIGNS LIST

1 electrode assembly
2, 31 roll
3 adhesive tape
4 negative electrode sheet (electrode sheet)
5 positive electrode sheet (electrode sheet)
6 first separator
7 second separator
8 separator
11 film base material
12 functional layer
13 tape base material
14 adhesive layer
15 void
16, 17, 18 end surface
21 cutting blade
23 negative electrode current collector (current collector)
24 negative electrode active material layer (active material layer)

1. An electrode assembly for a secondary battery, comprising:
a roll including an electrode sheet and a separator which are stacked, the electrode sheet or the separator being wound, the electrode sheet including an active material layer and a current collector, the separator including a functional layer and a film base material; and
an adhesive tape securing a terminal end portion of the roll on an outer side of the roll,
the adhesive tape being bonded (i) to an outer surface of the active material layer or an outer surface of the functional layer and (ii) to an end surface of the terminal end portion.

2. The electrode assembly as set forth in claim 1, wherein the adhesive tape is bonded, at the end surface of the terminal end portion, (i) to an end surface of the active material layer and an end surface of the current collector or (ii) to an end surface of the functional layer and an end surface of the film base material.

3. The electrode assembly as set forth in claim 1, wherein the end surface of the terminal end portion is inclined with respect to an outer surface of the terminal end portion.

4. The electrode assembly as set forth in claim 1, wherein an outermost layer of the roll is the separator.

5. The electrode assembly as set forth in claim 1, wherein:
the separator is a first separator;
the electrode assembly further comprises a second separator which includes a functional layer and a film base material; and
the adhesive tape is bonded (i) to the outer surface of the functional layer of the first separator or an outer surface of the functional layer of the second separator and (ii) to an end surface of the first separator at the terminal end portion and an end surface of a terminal end portion of the second separator.

6. A method for producing an electrode assembly for a secondary battery,
the electrode assembly including a roll including an electrode sheet and a separator which are stacked, the electrode sheet or the separator being wound, the electrode sheet including an active material layer and a current collector, the separator including a functional layer and a film base material;
the method comprising:
a winding step comprising stacking and winding the electrode sheet and the separator; and
an attaching step comprising securing a terminal end portion of the roll on an outer side of the roll with use of an adhesive tape so that the adhesive tape is bonded (i) to an outer surface of the active material layer or an outer surface of the functional layer and (ii) to an end surface of the terminal end portion.

7. The method as set forth in claim 6, wherein the attaching step comprises bonding, at the end surface of the terminal end portion, the adhesive tape (i) to an end surface of the active material layer and an end surface of the current collector or (ii) to an end surface of the functional layer and an end surface of the film base material.

8. The method as set forth in claim 6, wherein the end surface of the terminal end portion is inclined with respect to an outer surface of the terminal end portion.

9. The method as set forth in claim 6, wherein an outermost layer of the roll is the separator.

10. The electrode assembly as set forth in claim 6, wherein:
the separator is a first separator;
the winding step comprises stacking and winding the electrode sheet, the first separator, and a second separator, the second separator including a functional layer and a film base material; and
the attaching step comprises bonding the adhesive tape (i) to the outer surface of the functional layer of the first separator or an outer surface of the functional layer of the second separator and (ii) to an end surface of the first separator at the terminal end portion and an end surface of a terminal end portion of the second separator.
